(19) United States
(12) Patent Application Publication
(10) Pub. No.: US 2017/0188410 A1
(43) Pub. Date: Jun. 29, 2017

(54) ASYMMETRIC COMMUNICATION

(71) Applicant: Nokia Solutions and Networks Oy, Espoo (FI)

(72) Inventors: Ali Yaver, Wroclaw (PL); Venkatkumar Venkatasubramanian, Wroclaw (PL)

(73) Assignee: Nokia Solutions and Networks Oy, Espoo (FI)

(21) Appl. No.: 15/324,329

(22) PCT Filed: Jul. 8, 2014
(86) PCT No.: PCT/EP2014/064534

§ 371 Date: Jan. 6, 2017

(51) Int. Cl. H04W 76/04; H04W 72/08; H04W 72/14; H04W 28/08

(52) U.S. Cl. CPC H04W 76/043; H04W 28/08; H04W 72/082; H04W 72/14

(57) ABSTRACT

The invention is in relation to a method initiating a device discovery process communications between user terminals capable of communicating on device-to-device and cellular communications links in the cellular communications network; determining a first parameter indicating interference of transmissions from a first user terminal on a device-to-device communications link to a second user terminal; determining a second parameter indicating interference of transmissions from the first user terminal on a cellular communications link; applying, on the basis of the first parameter exceeding the second parameter, asymmetric communications between the user terminals such that transmissions from the first user terminal to the second user terminal are communicated over the cellular communications links via infrastructure of the cellular communications network and transmissions from the second user terminal to the first user terminal are communicated over the device-to-device communications link.

### FIELD

The invention relates generally to communications, more particularly to asymmetric communications.

### BACKGROUND

User equipment (UE) may communicate with another UE conventionally via base station(s), for example. Alternatively, it is proposed that the UEs may communicate directly by applying network resources dedicated to a cellular network for a device-to-device (D2D) communication. The D2D communication has proven to be network efficient by offloading the traffic processed in the base station(s), for example. Device-to-device (D2D) communications may be implemented as an underlay of a cellular network, such as an LTE-Advanced or 5G network. D2D communications enable new service opportunities and reduce the base station or node apparatus load for short range data intensive peer-to-peer communications. The cellular network may establish a new type of radio bearer dedicated for D2D communications and stay in control of the session setup and the radio resources without routing the user plane traffic.

### BRIEF DESCRIPTION

According to an aspect there is provided a method comprising initiating a device discovery process communications between user terminals capable of communicating on device-to-device and cellular communications links in the cellular communications network, determining a first parameter indicating interference of transmissions from a first user terminal on a device-to-device communications link to a second user terminal, determining a second parameter indicating interference of transmissions from the first user terminal on a cellular communications link, applying, on the basis of the first parameter exceeding the second parameter, asymmetric communications between the user terminals such that transmissions from the first user terminal to the second user terminal are communicated over the cellular communications links via infrastructure of the cellular communications network and transmissions from the second user terminal to the first user terminal are communicated over the device-to-device communications link.

According to an aspect there is provided a method comprising receiving information indicating resource allocation from a network apparatus, detecting an unsuccessful reception of a transmission in device-to-device communications with another user device, and requesting the network apparatus to relay at least the unsuccessful transmission in the device-to-device communications.

According to an aspect, there is provided a method comprising establishing a cellular communications link to a network apparatus and a device-to-device link to another user device, determining required transmission power for the device-to-device communications link and for the cellular communications link, and requesting the network apparatus to relay at least one of the following: user data and control information of the device-to-device communications over the cellular communications link, if the required transmission power is lower in the cellular communications link.

According to an aspect there is provided an apparatus comprising at least one processor and at least one memory including a computer program code, wherein the at least one memory and the computer program code are configured to, with the at least one processor, cause the apparatus at least to initiate a device discovery process communications between user terminals capable of communicating on device-to-device and cellular communications links in the cellular communications network, determine a first parameter indicating interference of transmissions from a first user terminal on a device-to-device communications link to a second user terminal, determine a second parameter indicating interference of transmissions from the first user terminal on a cellular communications link, apply, on the basis of the first parameter exceeding the second parameter, asymmetric communications between the user terminals such that transmissions from the first user terminal to the second user terminal are communicated over the cellular communications links via infrastructure of the cellular communications network and transmissions from the second user terminal to the first user terminal are communicated over the device-to-device communications link.

According to an aspect there is provided an apparatus comprising at least one processor and at least one memory including a computer program code, wherein the at least one memory and the computer program code are configured to, with the at least one processor, cause the apparatus at least to receive information indicating resource allocation from a network apparatus, detect an unsuccessful reception of a transmission in device-to-device communications with another user device, and request the network apparatus to relay at least the unsuccessful transmission in the device-to-device communications.

According to an aspect, there is provided an apparatus comprising at least one processor and at least one memory including a computer program code, wherein the at least one memory and the computer program code are configured to, with the at least one processor, cause the apparatus at least to establish a cellular communications link to a network apparatus and a device-to-device link to another user device, determine required transmission power for the device-to-device communications link and for the cellular communications link, and request the network apparatus to relay at least one of the following: user data and control information of the device-to-device communications over the cellular communications link, if the required transmission power is lower in the cellular communications link.

According to an aspect there is provided a computer program product for a computer, comprising software code portions for performing the steps of a method according to an aspect, when said product is run on a computer.

According to an aspect there is provided a computer program embodied on a computer-readable storage medium, the computer program comprising program to execute a process comprising initiating a device discovery process communications between user terminals capable of communicating on device-to-device and cellular communications links in the cellular communications network, determining a first parameter indicating interference of transmissions from a first user terminal on a device-to-device communications link to a second user terminal, determining a second parameter indicating interference of transmissions from the first user terminal on a cellular communications link, applying, on the basis of the first parameter exceeding the second parameter, asymmetric communications between the user terminals such that transmissions from the first user terminal to the second user terminal are communicated over the cellular communications links via infrastructure of the cellular communications network and transmissions from the second user terminal to the first user terminal are communicated over the device-to-device communications link.

According to an aspect there is provided a computer program embodied on a computer-readable storage medium, the computer program comprising program to execute a process comprising receiving information indicating resource allocation from a network apparatus, detecting an unsuccessful reception of a transmission in device-to-device communications with another user device, and requesting the network apparatus to relay at least the unsuccessful transmission in the device-to-device communications.

According to an aspect there is provided a computer program embodied on a computer-readable storage medium, the computer program comprising program to execute a process comprising establishing a cellular communications link to a network apparatus and a device-to-device link to another user device, determining required transmission power for the device-to-device communications link and for the cellular communications link, and requesting the network apparatus to relay at least one of the following: user data and control information of the device-to-device communications over the cellular communications link, if the required transmission power is lower in the cellular communications link.

According to an aspect there is provided an apparatus comprising means for carrying out a method according to an aspect.

### BRIEF DESCRIPTION OF THE DRAWINGS

In the following the invention will be described in greater detail by means of embodiments with reference to the attached exemplifying drawings, in which

FIG. 1 presents an example of communications network according to an embodiment;

FIGS. 2, 3a and 3b illustrate examples of methods for communicating on D2D and cellular communications links in a communications network according to some embodiments;

FIGS. 4a to 4c illustrate examples of various asymmetric communications link configurations according to embodiments;

FIG. 5 illustrates an example of a messaging diagram in a cellular communications network, according to an embodiment; and

FIGS. 6 and 7 illustrate examples of apparatuses according to some embodiments.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

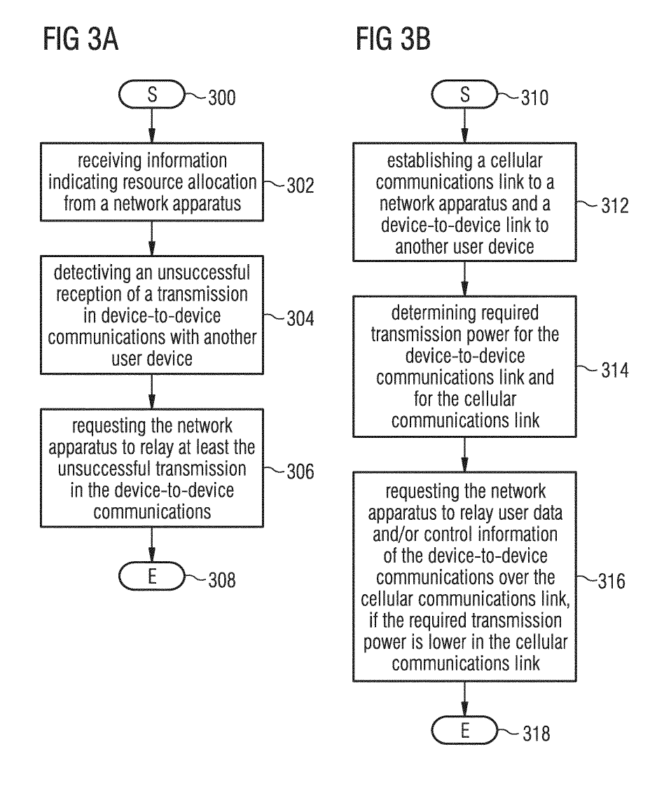

It should be appreciated that various embodiments, for example the examples in FIGS. 2 and 3, described herein may be employed in current communications systems, such as LTE (or -Advanced) or in future communications systems, such as 5G communications systems.

User equipment (UE) may communicate with another UE conventionally via base station(s), for example. Alternatively, it is proposed that the UEs may communicate directly by applying network resources dedicated to a cellular network for a device-to-device (D2D) communication. The D2D communication has proven to be network efficient by offloading the traffic processed in the base station(s), for example.

D2D communications allows extending the service area of the cellular communications network. The service area of the cellular communications network may be limited by the range of the wireless transmissions of user terminals and the base stations. Typically uplink direction of communications is more challenging than the downlink direction due to transmission power limitations of the UE.However, when resources dedicated to the cellular network are employed in D2D communications, the D2D communications may be observed as interference in the cellular network. The D2D communications could be observed as interference in the cellular network particularly if the transmission power of the UE for the D2D communications would be higher than its own or the nearby cellular users' transmission power towards base stations(s).

In the following description a direct link between user terminals is referred to a D2D communications link. Communications such as transmission of user data and/or control information over the D2D communications link is referred to as D2D communications. On the other hand an indirect link between user terminals is referred to a cellular communications link. Communications such as transmission of user data and/or control information over the cellular communications link is referred to as cellular communications. The cellular communications therefore includes a transmitter and a receiver pair formed by a user terminal and a base station. The base station is a part of the infrastructure of the communications network that provides a path for the user data and/or control information between user terminals. Communications over the D2D communications link includes a transmitter and a receiver pair formed by user terminals. The communications may be two-way communications, whereby the communicating devices operate both as a receiver and as a transmitter—On the other hand also one-way communications is possible, whereby one of the pair operates as a receiver and the other operates as a transmitter.

UEs may be located anywhere in the services area of the base station. This means that some UE may have a low transmission power and other UE may have a high transmission power. The differences in the transmission power may be due to differences in the communications channels between the UEs and the base station. A poor communications channel may require the UE to use a higher transmission power than another UE that has a good communications channel, in order to achieve reliable communications.

Various embodiments, for example the examples in FIGS. 2 and 3, described herein aim at avoiding or mitigating interference caused by using D2D communications for transmissions between user terminals in a cellular communications network. The D2D communications between UEs may cause interference particularly, when the UEs are connected by respective cellular communications links to the infrastructure of the cellular communications network, and one of the UEs has a higher communications channel quality over the cellular communications link than over the D2D communications link to the first user terminal, and the other UE has a lower communications channel quality over the cellular communications link than the first user terminal. Since the communications channel quality of the D2D communications link is lower than the quality of at least one of the cellular communications links, transmissions of user data and/or control information over the D2D communications link may cause interference, for example in terms of higher transmission power used over the D2D communications link and/or a number f of retransmissions needed over the D2D communications link.

Radio communication networks, such as the Long Term Evolution (LTE) or the LTE-Advanced (LTE-A) of the 3^{rd} Generation Partnership Project (3GPP), are typically composed of at least one base station (also called a base transceiver station, a radio network controller. a Node B, or an evolved Node B, for example), at least one user equipment (UE) (also called a user terminal, terminal device or a mobile station, for example) and optional network elements that provide the interconnection towards the core network. A base station may be node B (NB), evolved node B (eNB) or any other apparatus capable of controlling radio communication and managing radio resources within a cell. The base station may connect the UEs via the so-called radio interface to the network. In general, a base station may be configured to provide communication services according to at least one of the following radio access technologies (RATs): Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), LTE, and/or LTE-A. The present embodiments are not, however, limited to these protocols.

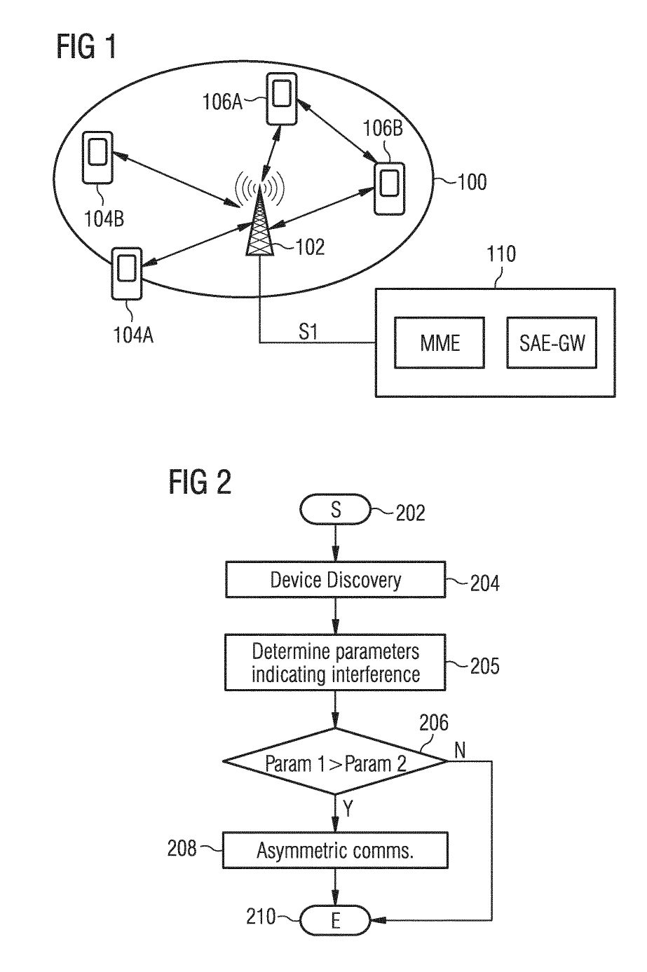

FIG. 1 shows an example of communications network where embodiments of the invention may be applicable. A base station 102 may be used in order to provide radio coverage to the cell 100. For the sake of simplicity of the description, let us assume that the base station is an eNB. In the case of multiple eNBs in the communication network, the eNBs may be connected to each other with an X2 interface, as specified in the LTE. The eNB 102 may be further connected via an 51 interface to an evolved packet core (EPC) 110, more specifically to a mobility management entity (MME) and to a system architecture evolution gateway (SAE-GW). The MME is a control plane for controlling functions of non-access stratum signaling, roaming, authentication, tracking area list management, etc., whereas the SAE-GW handles user plane functions including packet routing and forwarding, evolved-UMTS terrestrial radio access network (E-UTRAN) or LTE idle mode packet buffering, etc.

Still referring to FIG. 1, the eNB 102 may control a cellular radio communications links established between the eNB 102 and each of terminal devices 104A and 104B located within the cell 100. These communications links, illustrated by arrows between the terminals and the eNB, may be referred as conventional communications links or as cellular communications links for an end-to-end communication, where the source device transmits user data and/or control information to the destination device via the eNB 102. Therefore, the user terminals 104A and 104B may communicate with each other via the eNB 102. The terminal device may be a terminal device of a cellular communication system, e.g. a computer (PC), a sensor, a laptop, a palm computer, a mobile phone, or any other user terminal or user equipment capable of communicating with the cellular communication network.

In addition to or instead of conventional communications links, direct device-to-device (D2D), also known as mobile-to-mobile (M2M), terminal-to-terminal (T2T), peer-to-peer (P2P), connections may be established among terminal devices, such as terminal devices 106A and 106B. The D2D communication may be integrated into the cellular network, such as the LTE/LTE-A cellular network. The integration may denote that devices (or mobile or terminals or peers or machines) 106A and 106B having a direct physical communications link utilize the radio resources of the cellular network, thus sharing the cellular network resources with other devices 104A, 104B having the conventional cellular communication to the eNB. Terminal devices that have established a radio resource control (RRC) connection with the eNB 102 may have their D2D communications links 108 controlled by the eNB 102. The D2D links are illustrated by arrows between the terminals in FIG. 1. The D2D links may be controlled by the eNB over the cellular communications links. The control of a direct D2D communications link 108 may be carried out when an associated terminal device is either in an RRC idle state or in an RRC connected state.

The control may be performed over cellular communications links. The radio access technology of the direct communications link 108 may operate on the same frequency band as the conventional communications link and/or outside those frequency bands to provide the arrangement with flexibility. Thus, the eNB 102 may be responsible for allocating radio resources to the direct communications link 108 as well as for the conventional communications links. The cellular network may be operating in a frequency division duplex (FDD) mode and the D2D connections 108 may utilize time division duplex (TDD) mode with the cellular network uplink (UL) and/or downlink (DL) resources controlled by the base station(s), such as the eNB 102. The D2D UE 106A may apply the 2 0 UL resources in communication of data with the D2D UE 106B, and vice versa. The D2D UEs 106A, 106B may select the modulation and coding scheme (MCS) by themselves, without involvement by the eNB 102. The purpose of establishing a direct communication into the cellular network may be the possibility to reduce transmitter power consumption both in the user terminals (UTs) and in the eNB 102 (or any base station), increase the cellular network capacity and establishing more services for the users.

Before such direct D2D communication may take place, the user terminals may need to be aware of the presence of other user terminals capable of D2D communication. In order to enable this, a D2D discovery process may be applied. In the discovery process, the user terminal (UE) may, for example, inform other user terminals about the capability or desire to perform D2D communication directly with another UT. The other UTs may listen to such signalling and in this way also perform the D2D discovery process functions. The device discovery process may be controlled by the eNB or the device discovery process may be controlled by the D2D capable UEs.

In various embodiments, for example the examples in FIGS. 2 and 3, a D2D capable UE may use one or more D2D communications links and one or more cellular communications links for transmission of user data and/or control information to a recipient UE that is also D2D capable. By D2D capable it may be meant that the UE 106A and 106B are equipped with an UL receiver for receiving data transmitted by using the UL resources. Additionally the UE 106A and 106B may also be equipped with a DL transmitter for transmitting data using DL resources. The DL receiver of the UE listens to the eNB for receiving control signaling transmitted on DL resources from the eNB.

Accordingly, the UE may comprise an additional UL receiver such that the transmission may be received on the UL resources without tuning the DL receiver to receive the UL transmissions and possibly end up missing D2D commands or paging/data information from the eNB during the ongoing D2D communications. Symmetric communications between D2D UEs may refer to communications, where user data and/or control information transmitted in both directions between the UEs has the same number of hops. A hop in a communications link may refer to a connection between two endpoints in a communication path. The endpoints may be the communicating parties, for example UE and/or eNB, or protocol entities, for example an application(s), within the communicating parties. A single hop is defined by a source endpoint and a destination endpoint that decodes a transmission encoded by the source endpoint. Symmetric communications may take place on a direct connection between UEs or via cellular communications links between the UEs and the eNB.

Asymmetric communications between D2D UEs may refer to communications, where data and/or control information transmitted in different directions has a different number of hops. A D2D communications link counts as a single hop. On the other hand a communications of user data and/or control information over via eNB includes at least two hops: one hop from the source UE to the eNB and a second hop from the eNB to the destination UE. Forwarding user data and/or control information received from the source UE towards another eNB or to a core network increases the number of hops. In the asymmetric communications the eNB may act as a relay such that it forwards user data and/or control information received on a cellular communications link towards one UE to a cellular communications link towards another UE.

FIGS. 2 and 3 illustrate examples of methods for communicating on a D2D and cellular communications links in a communications network according to some embodiments. The communications network may be the communications network illustrated in FIG. 1. In the communications network, one of the UEs may be located closer to eNB than the other and the distance between the UEs is longer than the shortest distance between the UEs and the eNB. In such a configuration, the UE with the shortest distance to the eNB may have a higher quality communications channel, e.g. in terms of pathloss, to the eNB than other UEs. For this reason, communications on the D2D communications link may increase interference in the communications network, for example due to the UE using a higher transmission power on the D2D communications link than towards the eNB and/or retransmissions over the D2D communications channel.

Referring now to FIG. 2, the method may be performed by eNB in the network of FIG. 1 or by another apparatus capable to control communications. The method starts in block 202. The eNB may be operational and may has established cellular communications links to one or more UEs. The connection may be a control plane connection, for example an RRC connection. In addition to the RRC connection, also one or more user plane connections for communicating user data maybe have been established between the UE and the eNB.

In 204, a device discovery process communications between user terminals capable of communicating on device-to-device and cellular communications links in the cellular communications network may be initiated.

The eNB may initiate a device discovery process between D2D capable UEs. The device discovery process may be controlled by the eNB or the device discovery process may be controlled by one or more of the D2D capable UEs. In the device discovery process controlled by the UEs, the eNB may assist the D2D capable UEs to discover each other. The device discovery process may comprise communicating information over cellular communications links and/or directly between the D2D capable devices. It should be appreciated that also direct communications between the D2D capable devices in the device discovery process may precede establishment of a D2D communications link. The communications preceding the D2D communications link may be performed out of band, i.e. on communications resources, e.g. frequency band, that is not used by the cellular communications network. The device discovery process provides that a D2D capable UE that has user data and/or control information to be transmitted may be discovered by one or more recipient D2D capable UEs, whereby user data and/or control information may be communicated over a direct connection between the UEs. Discovery of the UE may be based on received power, dedicated beacon message etc. The discovery process may be carried out in a pre-defined tracking area or a discovery range.

When controlled by the eNB, the device discovery process may comprise the eNB determining which UEs are enabled to transmit discovery or dedicated beacon signals and at which instance of time, the information the discovery signals comprise, etc.

In 205 a parameter ‘Param 1’ indicating indicating interference of transmissions from a user terminal on a device-to-device communications link to another user terminal may be determined, and a parameter ‘Param 2’ indicating interference of transmissions from the user terminal on a cellular communications link may be determined. The parameters may be determined as a part of the interference control in 204, for example as a part of transmission power control.

The parameters may be determined with respect to interference caused to the cellular communications network. Interference to the cellular communications network may degrade service quality provided by the network. The service quality may be measured with respect to individual physical or logical entities of the network, for example cells, eNBs or controllers. On the other hand the service quality may be measured with respect to multiple physical or logical entities at a time to have an overall understanding of service quality provided by a specific part of the network or the whole network. The interference may be measured by parameters comprising one or more from a group comprising transmission power, pathloss and signal quality.

The parameter ‘Param 1’ indicating interference caused by transmissions of the UE on a D2D communications link may be determined based on an estimated interference caused by the UE transmitting on the D2D communications link to the recipient UE. The parameter ‘Param 2’ indicating interference caused by transmissions on the cellular communications link may be determined based on the current cellular communications link of the UE to the eNB by performing measurements with respect to the parameter, for example transmission power, pathloss and signal quality.

The interference may be due to a transmission power exceeding a threshold for the transmission power. The interference may also be observed additionally or alternatively in one or more other parameters that include at least one of pathloss and signal quality. The signal quality may be determined for example based on a Block Error Rate (BLER) of data blocks. The threshold may be set such that if an estimated interference, e.g. estimated transmission power of the UE, is below the threshold, at least one D2D communications link may be applied between D2D capable UEs. Corresponding thresholds may be set for one or more of the other parameters indicating interference. In the following description many of the embodiments are described by using the transmission power as an example of the parameter indicating interference, but also additionally or alternatively one or more other parameters described above may be used in order to mitigate or avoid interference measured by the specific parameter.

Measurements of the communications channel quality received from the UEs may be used to estimate a change of the communications channel quality if instead of the cellular communications link the D2D communications link is used for transmissions. The communications channel qualities may be defined by pathlosses corresponding to the links. The change of the communications channel qualities may be used to determine the parameter indicating interference caused by transmissions over the D2D communications link.

The communications channel quality may be determined by pathloss of the communications channel. Interference caused by the UE transmitting on the D2D communications link instead of the cellular communications link may be estimated on the basis of determining change of pathloss between the cellular communications link and the D2D communications link. A higher pathloss on the D2D communications link may cause the UE to increase its transmission power and thereby cause more interference to the cellular network than if the cellular communications link would be used. The higher pathloss may also be observed in increased number of retransmissions.

In some embodiments a parameter indicating interference may refer to transmission power, pathloss or signal quality, for example a block error rate. Statistical information of correlation between a communications channel quality and one or more of the parameters may be used to estimate the parameters for transmissions over the D2D communications link.

The transmission power of the UE may be determined by the eNB as part of the transmission power control functionalities. Measurements of communications channel quality performed by the UE may be used in determining the transmission power. The determined transmission power may be used to generate a power control command for setting the transmission power control of the UE to the determined transmission power. The transmission power may be expressed as an absolute or relative value. An indicator may be used to refer to the determined transmission power value.

In 206 it may be determined whether the parameter Param 1′ indicating interference caused by transmissions on the D2D communications link exceeds the parameter ‘Param 2’ indicating interference caused by transmission on the cellular communications link. Accordingly, the parameter indicating interference over the cellular communications link may determine a threshold. If the threshold is exceeded, asymmetric communications between the user terminals may be applied 208 such that transmissions from a first user terminal to the second user terminal are communicated over the cellular communications links via infrastructure of the cellular communications network and transmissions from the second user terminal to the first user terminal are communicated over the D2D communications link. In this way configuration of communications links used for communications between the UEs may be adapted for mitigating or avoiding interference. In the communications via the infrastructure of the communications network, one or more nodes of the communications network may perform relaying of the user data and/or control information towards the recipient UE.

When the D2D communications link is used between the UEs for communications, there is a possibility that the D2D communications may be observed as interference in the cellular communications network. This is particularly likely, when one of the UEs is located near to the base stations and the other UE is located far from the base station, whereby UE near the base station may have to use a high transmission power for the D2D communications. However, interference caused by the D2D communications maybe mitigated or even avoided by applying the asymmetric communications between the UEs.

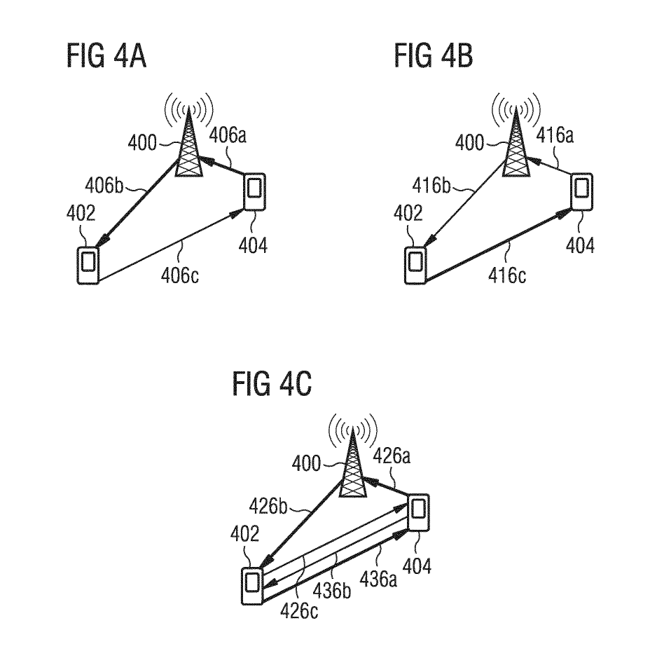

In an embodiment, asymmetric communications may be applied by determining a communications link configuration between D2D capable UEs on the basis of the parameters determined in 205. Examples of communications link configurations are described below with FIGS. 4a, 4b and 4c. The communications link configuration may be defined by communications modes, for example the communications modes described in the below table of communications modes. The communications link configurations allow a D2D capable UE to use one or more D2D communications links and one or more cellular communications links for transmission of user data and/or control information to a recipient UE that is also D2D capable.

If the threshold is not exceeded in 206, the process may proceed to 210, where communications between the UE may be symmetric such that user data and/or control information may be communicated via the cellular communications links between the UEs. Alternatively, user data and/or control information may be communicated via the D2D link. The communications may be in both directions or in one direction between the UEs.

In an embodiment, asymmetric communications may be applied by establishing cellular and/or D2D communications links between the UEs by allocating resources to the communications links. The allocated resources are the resources of the cellular communications network under whose service area, for example coverage area, at least one or both of the UEs are located. A device discovery process may allow UE that is capable of D2D communications to obtain knowledge of one or more other UE capable of D2D communications. This knowledge may be used in the establishment of the communications links.

In an embodiment the parameter indicating interference caused by transmissions over the cellular communications link may be a fixed threshold value, or the parameter may be determined by measurements of the current cellular communications link. In the latter case the parameter is dynamic, whereby current conditions, for example traffic load and interference, over the cellular communications link may be reflected to the parameter used as threshold.

In an embodiment, in 206 an estimated transmission power ‘Param 1’ of the UE over a D2D communications link is evaluated against a threshold ‘Param 2’ for the transmission power. The threshold for the transmission power may be a current transmission power of the UE over the cellular communications link towards the eNB. The threshold may be defined as a relative or absolute value of the transmission power. In this way the, high transmission power levels between the UEs on a D2D communications link may be avoided, whereby interference levels in the cellular network may be kept acceptable.

If the estimated transmission power of the UE is greater than the threshold the method proceeds to 208, where the asymmetric communications between the user terminals may be applied as described above. In the asymmetric communications the D2D communications link may be applied only in one direction of communications between the UEs and/or for a specific type of information communicated between the UEs. The type of information communicated between the UEs may comprise user data and/or control information. Preferably the D2D communications link is applied in one direction and a cellular communications link is applied in another direction of communications between the UEs. In this way the type of communicated data may be used to determine which communications link of the D2D and cellular communications link is used.

If the estimated transmission power ‘Param 1’ of the UE is less or equal to the threshold ‘Param 2’, the method may proceed to 210, where the data and/or control information is communicated on a cellular communications link between the UE and the eNB. Communications between UEs is symmetric, whereby both UEs communicate on cellular communications links or D2D communications links. In an embodiment, the D2D communications link applied between the UE and a recipient UE in the cellular network provides asymmetric communications between UEs in the cellular communications network. The asymmetric communications may be provided by allocating resources to cellular communications links and a D2D communications links between the UEs. The allocation may be performed by the eNB transmitting a resource allocation to each of the UE. The resource allocation may be a signaling message and include information indicating allocated resources to one or more UEs for communications on at least one of a cellular communications link, a D2D communications link and both a cellular communications link and a D2D communications link.

The information indicating allocated resources may comprise information indicating a specific time and frequency band allocated for the specific time of communications. The specific time may be a time slot in a defined communications time frame, for example 0.5 ms in a 10 ms frame as is defined in the LTE. In the LTE, the resource allocation may be a scheduling grant on a Physical Downlink Control Channel (PDCCH). The scheduling grant may comprise downlink resource scheduling information, uplink power control instructions and uplink resource grant information. It should be appreciated that also other frame lengths may be used depending on the specifications of the underlying communications system.

In an embodiment, resource allocation, for example a scheduling grant, may include a resource allocation for a D2D communications link. The resource allocation may include at least one of information indicating allocated resources, information indicating a cellular communications link, information indicating a D2D communications link and information indicating the type, for example data and/or control information, of communicated information.

In an embodiment, communications links for asymmetric communications may be provided by resource allocations concerning more than one communications link. A single resource allocation may be used to allocate resources for the D2D communications link and the cellular communications links. It is also possible to use separate resource allocation messages, e.g. scheduling grants, for each the cellular and D2D communications links. Resource allocations to UEs for cellular communications links between the UEs may include corresponding information needed by the UEs to communicate user data and/or control information to/from the eNB.

It should be appreciated that information indicating allocated resources for communications may be transmitted to one or more user terminals before the actual transmission of data and/or control information between the user terminals. The allocated resources for communications may be sent in a scheduling grant message that may include information indicating the allocated resources and whether to use a D2D communications link, a cellular communications link or both a D2D communications link and a cellular communications link for communications between the user terminals, and a direction of communications, the resources are applied in. The allocation of resources may be performed in an eNB of the communications network using available resources defined by frequency spectrum, time, codes or their combinations.

In an embodiment a resource allocation may include an indicator of communications mode to be applied between D2D capable UEs. The communications modes may comprise symmetric and asymmetric communications between the UEs. Different communications modes are described in more detail below.

Resource allocations to UEs for the D2D communications link may be communicated to the UEs such that the resource allocation to the UE transmitting user data and/or control information on the D2D communications link is copied to the resource allocation of the UE receiving, the recipient UE, on the D2D communications link. A scheduling grant to the recipient UE may include an indication, whether to receive data and/or control information on the cellular or the D2D communications link from the transmitting UE.

In an embodiment, interference caused by a user terminal in a cellular communications network may be controlled. The eNB may perform interference control functionalities for controlling interference caused by the UE in the cellular communications network. The interference control functionalities may comprise power control functionalities for controlling transmission power of the UE, but it should be appreciated that also other interference control functionalities may be performed. The transmission power control functionalities may include measuring communications channel quality for example attenuation of the radio channel or informing another apparatus to carry out such measurements and/or communicating power control commands to the UE for controlling the transmission power of the UE. Each power control command received by the UE may cause a stepwise increase or decrease of the transmission power. It is also possible that the power control command causes no changes to the transmission power and the current transmission power of the UE is maintained. For carrying out the transmission power control in the eNB, the UE may be tasked to carry out measurements of communications channel quality and send the results of the measurements to the eNB. The transmission power control functionalities may be performed continuously, whereby at each time instant, for example a time slot, the UE is determined a current transmission power.

A network apparatus (node, base station, server, host, etc.) may act as a relay in device-to-device communications. In one embodiment, the node obtains a request for relaying a transmission transmitted over the device-to-device communications link unsuccesfully (the reception fails at least partly) or for relaying a transmission targeted to the device-to-device link (the transmission (data or control information) was originally scheduled or planned to be transmitted over the device-to-device link), and carries out the relaying of the transmission. In another embodiment, the network apparatus analyzes, over the cellular communications link and over the device-to-device communications link, at least one of the following: transmission power and interference requirements, and relays a transmission targeted to the device-to-device communications link, when communications over the cellular communications link (or using cellular infrastructure, such as frequency allocated to the cellular communications) is determined to be needed for fulfilling interference requirements. The interference requirements may be in relation to interference control in order to limit the interference caused to other devices nearby.

The method ends in 210, after the parameter indicating interference caused by transmissions over the D2D communications link has been used for selecting communications links between the UEs. The selection of the communications links on the basis of the interference related parameter as described above allows to adaptively apply asymmetric communications between the D2D capable UEs.

Referring now to FIGS. 3a and 3b, the method may be performed by UE in the network of FIG. 1 or by any user terminal or user device.

The eNB and/or the UE may be performing interference control functionalities for controlling interference caused by the UE in the cellular communications network. The interference control functionalities may comprise for example the interference control functionalities described above. The connection may be a control plane connection, for example an RRC connection. In addition to the RRC connection, also one or more user plane connections for communicating user data and/or control information may be established between the UE and the eNB. User data and/or control information may be transmitted between the UE and the eNB over a cellular communications link.

A device discovery process between D2D capable UEs may be initiated. The device discovery process, may be performed for obtaining information of at least one other D2D capable UE for establishing the D2D communications link to the discovered UE. The interference may be controlled by controlling a transmission power of the UE. The controlling may be performed on the basis of power control commands obtained from the eNB. A power control command may be obtained in a resource allocation message, for example in a scheduling grant. The resource allocation may indicate communications resources that have been allocated for UEs. The resources may be resources of the cellular communications network for communicating on D2D and cellular communications links. The UEs may be both capable of communicating on D2D and cellular communications links. In an embodiment the allocated resources may be uplink resources of the cellular network.

Embodiments of FIGS. 3a and 3b may be carried out as a part of the above described asymmetric communications, wherein communications between the user terminals is carried out in such a manner that a transmission from the first user terminal to the second user terminal is communicated over the cellular communications links via infrastructure of the cellular communications network and a transmission from the second user terminal to the first user terminal is communicated over the device-to-device communications link.

The embodiment of FIG. 3a starts in block 300.

In block 302 information indicating resource allocation from a network apparatus is received.

The information may comprise an indication on radio interface resources used communications, for example a resource a receiving user device should listen to. The information may comprise resource allocation a cellular communications link and/or a device-to-device communications link. The network apparatus may be a base station or node.

In block 304, an unsuccessful reception of a transmission in device-to-device communications with another user device is detected.

The unsuccessful reception may mean that a transmission was not received at all, a received signal was not successfully detect, etc.

In block 306, the network apparatus is requested to relay at least the unsuccessful transmission in the device-to-device communications.

The request may be conveyed by transmitting signaling information to the network apparatus.

In an embodiment, when user data is expected to be received by a recipient D2D UE on a cellular communications link, control information may be caused to be transmitted by the recipient D2D UE on a D2D communications link or the cellular communications link. The control information may indicate a failure or success of the reception of the user data. The cellular communications link may be selected for the control information due to power saving reasons in the UE. The UE may be executing a power saving functionality in order to save power during operation. The power saving functionality may be triggered by a level of remaining energy stored in a battery of the UE reaching a threshold level. When the power saving functionality is on or triggered, the cellular communications link may be selected for transmission of the control information, when a lower transmission power is required on the cellular link compared to the D2D link. Suitable threshold levels for the remaining energy in the battery may be a relative battery charging level, e.g. 10%, 20% or 30% of the fully charged battery.

The embodiment ends in block 308.

The embodiment of FIG. 3b starts in block 310.

In block 312, a cellular communications link to a network apparatus and a device-to-device link to another user device are established. The cellular communications link may be a “normal” communications link used for communicating with a cellular network and not established particularly for this purpose. The device-to-device link may be established by using a discovery process described above. The network apparatus may be a base station or node.

In block 314, required transmission power using the device-to-device communications link and using the cellular communications link is determined.

The determination of the required transmission power may be based on interference evaluation based on measurement and/or prediction on the basis of statistical information on interference. In principle, the higher the interference over the link is, the higher the needed transmission power. On the other hand, if the needed transmission power is high, it may increase the interference level in the network and thus cause problems to other users. Therefore, interference needs to be controlled.

In block 316, the network apparatus is requested to relay user data and/or control information of the device-to-device communications over the cellular communications link, if the required transmission power is lower in the cellular communications link. Using the link which needs smaller transmission power assist in controlling the total interference level in the network. Some interference control options are discussed in further detail above.

The embodiment ends in block 318.

In various embodiments, for example the examples in FIGS. 2 and 3, the control information communicated between UEs in the cellular network either on a D2D communications link or on cellular communications links via the eNB, may comprise feedback information, for example feedback on success or failure of transmission of user data, or feedback on channel quality on the cellular communications link or the D2D communications link. Success or failure of transmission of user data may be indicated by positive or negative acknowledgements (ACK/NACK), or a Hybrid Automatic Repeat Request (HARQ) feedback.

FIGS. 4a, 4b and 4c illustrate examples of various asymmetric communications link configurations according to embodiments. The various configurations may be provided by applying a D2D communications link and cellular communications links between D2D capable UEs as described in the above methods. The D2D capable UEs may be UEs in the communications network of FIG. 1. The eNB and the UEs may be executing the processes described in FIGS. 2 and 3. Resource allocations, for example scheduling grants, from the eNB may be used to allocate resources to cellular communications links 406a, 406b, 416a, 416b, 426a, 426b and D2D communications links 406c, 416c, 426c, 436a, 436b illustrated in FIGS. 4a, 4b and 4c. In the illustrations of the communications link configurations, communications of user data is illustrated by thick arrows and communications of control information is illustrated by thin arrows.

The communications links are established between UEs 402, 404 that are capable of communicating on both a cellular communications link and a D2D communications link. Cellular communications links are established between the UE and the eNB 400. The eNB may relay user data and/or control information received on the cellular communications link.

FIG. 4a illustrates a communications link configuration, where the user data is transmitted via the eNB on the cellular communications link to the UE 402. Control information from the UE 402 to the UE 404 is transmitted on the D2D communications link.

FIG. 4b illustrates a communications link configuration, where control information is transmitted via the eNB on the cellular communications link to the UE 402. User data from the UE 402 to the UE 404 is transmitted on the D2D communications link.

FIG. 4c illustrates transmission of from both of the UEs. User data from the UE 404 is transmitted to the UE 402 similar to explained in FIG. 4a. User data from the UE 402 is transmitted to the UE 404 similar to explained in FIG. 4b. Control information is transmitted between the UEs over the D2D communications link.

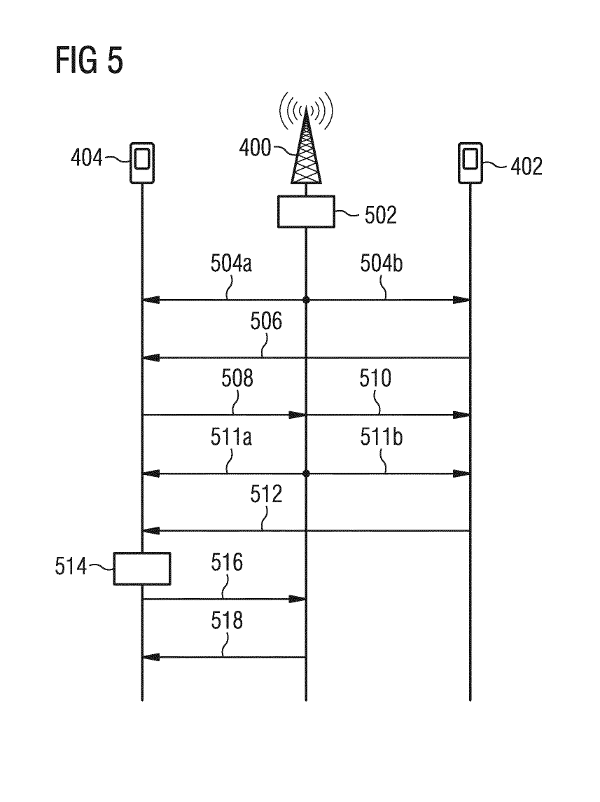

FIG. 5 illustrates an example of a messaging diagram in a cellular communications network, according to an embodiment. The messaging diagram is described with reference to the eNB 400 and UEs 402, 404 in FIGS. 4a to 4c. The eNB and UEs may be executing the methods described above. The eNB may perform 502 transmission power control including monitoring transmission power levels of the UEs to determine when to apply asymmetric communications between the UEs, as described in the method of FIG. 2, for example. Additionally, device discovery may be performed. In items 504a through 510 one example of a message flow according to an embodiment is described. In items 511a through 518 another example of a message flow according to an embodiment is described.

In 504a, 504b, the eNB may perform resource allocation for the UEs such that asymmetric communications may be performed between the UE. The asymmetric communications may be applied between the UEs by resource allocations. The resources allocation may be comprise transmission of scheduling grants as described above. In 506 transmission of user data takes place over a D2D communications link. In 508 and 510 transmission of user data and/or control information takes place over cellular communications links. Configuration of the communications links may be as described above in FIG. 4b or 4c. Control information may be sent over a cellular communications link to the UE 402 that originated the user data over the D2D communications link.

In 512 another transmission of user data from UE 402 to UE 404 is illustrated. The transmission takes place after resource allocations for the transmission in 511a and 511b. The resource allocation may be performed in a similar manner as in 504a and 504b. In 514, the recipient UE determines that user data was not successfully received in the allocated resources. The recipient UE sends 516 a signaling message to the eNB. The signaling message indicates the eNB that the communications of the user data failed. The failure may be determined for example on the basis of failure to decode the user data. In 518 the eNB sends the user data anew to the recipient UE, after being notified about the failure in 516.

It should be appreciated that in various embodiments, for example the examples in FIGS. 2 and 3, the eNB may be within a range of the D2D communications, whereby the eNB may receive the user data and/or control information communicated on the D2D communications link.

Various embodiments, for example the examples in FIGS. 2 and 3, described above apply communications between D2D capable UEs by communications link configurations for asymmetric or symmetric communications. The communications link configurations may be defined by communications modes. Examples of the modes are given in the following table:

| | | |
|---|---|---|
| Mode 0 | User data sent on D2D link | Feedback sent on D2D link |
| Mode 1 | User data sent through BS | Feedback sent through BS |
| Mode 2 | User data sent through BS | Feedback sent on D2D link |
| Mode 3 | Data sent as direct D2D | Feedback sent through both |
| | | a D2D link and through BS |
| Mode 4 | User data sent through BS | Feedback sent through both |
| | | direct D2D and through BS |
| Mode 5 | User data sent on D2D link | Feedback sent on D2D link |
| | and through BS | and through BS |

The communications modes illustrated in the table are only exemplary and also further communications may be used between D2D capable devices. The communications modes may be applied independently to the D2D capable UEs. To apply a communications mode in the D2D capable UE, the eNB may cause to transmit a signaling message, for example a scheduling grant that includes information indicating the communications mode to be by the UE. In the above examples listed in the table, a three bit message as a message part of the scheduling grant may be sufficient to indicate one of the communications modes. Mode 0 indicates symmetric communications on a D2D link. Mode 1 indicates symmetric communications via the eNB, whereby communications of the D2D capable is assisted by the eNB. Mode 2 indicates asymmetric communications illustrated for example in FIGS. 4a and 4c. Modes 3 and 4 indicate asymmetric communications, where control information is communicated via the eNB and also on a D2D link. In modes 3 and 4, the user data is transmitted on the D2D link similar to FIG. 4b or on cellular link similar to FIG. 4a. Using two routes for the control information improves reliability of the delivery of the control information. Mode 5 is an extension of modes 3 and 4 and adds diversity gain to both user data and control information. This can be useful for data delivery which is of critical nature, such as related to security and/or delay.

Referring to FIG. 5, an embodiment provides communications of user data and/or control information over a cellular communications link to a recipient UE 404 upon failure of the communications of user data and/or control information over a D2D communications link to the recipient UE. The eNB 400 in the cellular communications network may obtain at least one of user data 512 and control information 512 communicated by the UE to the recipient UE on cellular network resources allocated for a D2D communications link. Upon failure of the communications of the at least one of the user data and control information, the eNB is caused to transmit 518, the obtained at least one of the user data and control information to the recipient UE. In this way, the cellular communications link to the recipient UE may be used as a fallback in case of failures on the D2D communications link. Preferably the cellular communications link is used as fallback in response to the recipient UE sending 516 a signaling message to the eNB for indicating unsuccessful reception of user data 512 and/or control information 512 over a D2D communications link. In this way the signaling message may be effectively used as a request to the eNB to send the failed transmission on the D2D communications link over the cellular communications link. The eNB may allocate resources of the cellular communications network for communications on at least one of a cellular communications link, a D2D communications link and both a cellular communications link and a D2D communications link. Accordingly, a communications link configuration between UEs may be applied on the basis of a request to allocate resources of the cellular communications network.

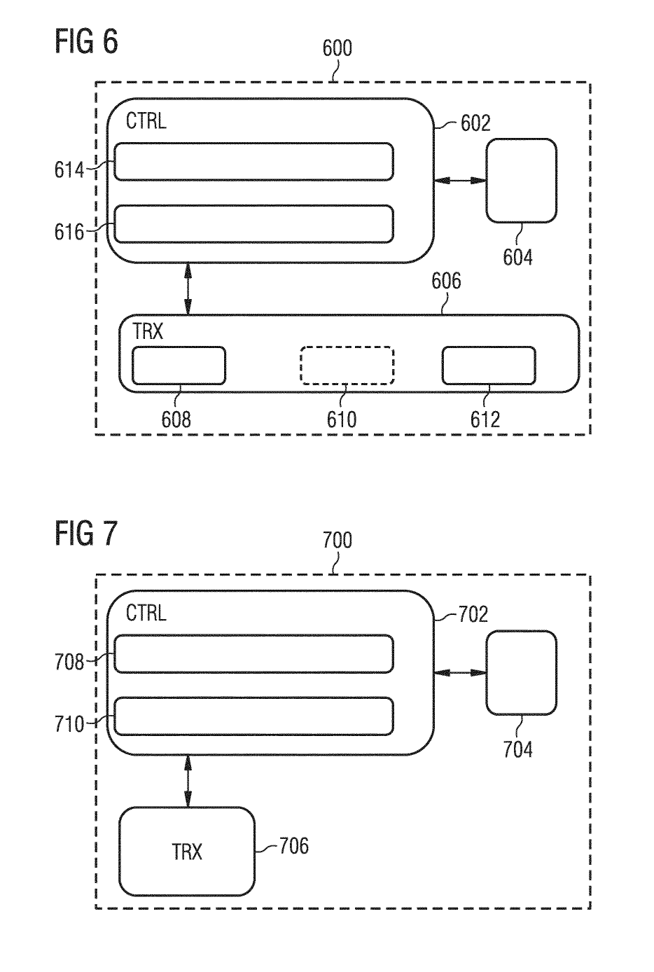

FIGS. 6 and 7 provide examples of apparatuses 600 and 700, according to some embodiments. The apparatuses comprise at least one processor 602, 702 and at least one memory 604, 704 including a computer program code, wherein the at least one memory 604, 704 and the computer program code are configured, with the at least one processor 602, 702, to cause the apparatus 600, 700 to carry out any one of the above-described processes or embodiments in relation to FIGS. 3 to 5. It should be noted that FIGS. 6 and 7 show only the elements and functional entities required for understanding the apparatus 600 and 700. It is apparent to a person skilled in the art that the apparatus may also comprise other functions and structures. The at least one processor 602, 702 may be implemented with a separate digital signal processor provided with suitable software embedded on a computer readable medium, or with a separate logic circuit, such as an application specific integrated circuit (ASIC). The at least one processor 602, 702 may comprise an interface, such as computer port, for providing communication capabilities.

The apparatus 600 may comprise, be or be comprised in a terminal device, UE or user device of a (cellular) communications system, e.g. a computer (PC), laptop, tabloid computer, cellular phone, communicator, smart phone, palm computer, phablet, multimedia device or any other communication apparatus. The apparatus may comprise or be a circuitry, e.g. at least one chip, chip set, processor, micro controller, or a combination of such circuitries capable of causing the terminal device to carry out the above-described functionalities. Additionally, the apparatus 600 may be or comprise one or more modules (to be attached to the UE) providing connectivity, such as a plug-in unit, an “USB dongle”, or any other kind of unit. The unit may be installed either inside the UE or attached to the UE with a connector or even wirelessly.

In another embodiment, the apparatus 600 may be seen as the D2D UE described for example in items 402, 404. In this case, the UL receiver 610 may be present in the apparatus in order to receive UL data on Uplink resources.

As shown, the apparatus 600 may further comprise radio interface components (TRX) 606 providing the apparatus with radio communication capabilities with the radio access network. The radio interface components 606 may comprise an UL transmitter 608 for transmitting data on UL resources, a downlink receiver 612 for receiving data on DL resources, and, when the apparatus is the D2D UE 404, an UL receiver for receiving data on UL resources. Further, the TRX 606 may comprise standard well-known components such as amplifier, filter, frequency-converter, (de)modulator, and encoder/decoder circuitries and one or more antennas.

The memory 604 may be used to store data related to the communications link configuration, communications mode, battery energy level threshold, transmission power, signal quality, pathloss, operational parameters of the communication scheme, HARQ buffer, communications channel quality related data, sounding signal configuration, etc.

The at least one processor 602 may comprise a D2D communication circuitry 614. The circuitry 614 may perform functions according to the symmetric D2D communication scheme and/or according to the asymmetric D2D communication scheme. Thus, it may acquire information on which scheme is to be applied and adjust the operational parameters of the apparatus 600 accordingly, for example. The at least one processor 602 may also comprise an interference control circuitry 616 for performing the control of interference caused by the user terminal in a cellular communications network and/or power saving functionality. The interference may be measured by various parameters indicating interference.

FIG. 7 shows another example of an apparatus. The apparatus 700 may be comprised, be or be comprised in a base station (also called a base transceiver station, a Node B, or an evolved Node B, for example), node, host or server. The apparatus 700 may comprise a circuitry, e.g. at least one chip, chip set, processor, micro controller, or combination of such circuitries in the base station, node, host or server for causing the base station to carry out the above-described functionalities in relation to FIGS. 2, 4 and/or 5. The apparatus 700 may comprise transceiver, or be operably coupled to one, 706 providing radio communication capabilities. The TRX 706 may forward the data and/or control information to the UE 402, 404 over cellular communications links, for example.

The memory 704 may store information about the threshold for transmission power of the UE, a threshold for pathloss, a threshold for signal quality, operation parameters for each communication scheme, etc.

The at least one processor 702 may comprise a D2D communication circuitry 708 for performing control functionalities of the D2D communication, such as controlling the use of resources of the cellular network, performing interference control in cellular communications network, causing forward of data over cellular communications links, etc. The interference control may be performed on the basis of various parameters indicating interference. The at least one processor 702 may also comprise a mode (i.e. communication scheme) determination circuitry 710 for determining which communication scheme to apply among the plurality of communication schemes. For this the circuitry 710 may use the knowledge of the D2D capabilities of the UEs and parameters indicating interference, for example transmission powers of the UEs 402 and 404.

As used in this application, the term ‘circuitry’ may refer to the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network apparatus, or another network apparatus.

The techniques and methods described herein, for example in FIGS. 2, 3 and 5, may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

The processes or methods described above in connection with FIGS. 2 to 5 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Apparatuses, such as base stations, nodes, servers or hosts, corresponding modules and/or other corresponding devices or apparatuses implementing the functionality of a corresponding apparatus described with an embodiment may comprise not only prior art means, but also at least one of the following: means for controlling interference caused by a user terminal in a cellular communications network, initiating a device discovery process communications between user terminals capable of communicating on device-to-device and cellular communications links in the cellular communications network, determining a first parameter indicating interference of transmissions from a first user terminal on a device-to-device communications link to a second user terminal, determining a second parameter indicating interference of transmissions from the first user terminal on a cellular communications link, applying, on the basis of the first parameter exceeding the second parameter, asymmetric communications between the user terminals such that transmissions from the first user terminal to the second user terminal are communicated over the cellular communications links via infrastructure of the cellular communications network and transmissions from the second user terminal to the first user terminal are communicated over the device-to-device communications link.

Apparatuses, such as user devices, corresponding modules and/or other corresponding devices or apparatuses implementing the functionality of a corresponding apparatus described with an embodiment may comprise not only prior art means, but also means for receiving information indicating resource allocation from a network apparatus means for detecting an unsuccessful reception of a transmission in device-to-device communications with another user device, and means for requesting the network apparatus to relay at least the unsuccessful transmission in the device-to-device communications.

Additionally or optionally, apparatuses may comprise means for establishing a cellular communications link to a network apparatus and a device-to-device link to another user device, means for determining required transmission power using the device-to-device communications link and using the cellular communications link, and means for requesting a network apparatus to relay at least one of the following: user data and control information of the device-to-device communications over the cellular communications link, if the required transmission power is lower in the cellular communications link.

More precisely, the apparatuses may comprise means for implementing functionality of a corresponding apparatus described with any embodiment disclosed above and they may comprise separate means for each separate function, or means may be configured to perform two or more functions. Present apparatuses comprise processors and memory that can be utilized in an embodiment. For example, control circuitry 602 (or a part of it, such as 614) or 702 (or a part of it, such as 710) may be software applications or portions thereof, modules, or units configured as arithmetic operations, or as programs (including an added or updated software routine), executed by an operation processor. Programs, also called program products, including software routines, applets and macros, can be stored in any apparatus-readable data storage medium and they include program instructions to perform particular tasks. All modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a UE, base station, a corresponding UE module or a corresponding base station module may be configured as a computer or a microprocessor, such as single-chip computer element, including at least a memory for providing storage area used for arithmetic operation and an operation processor for executing the arithmetic operation. An example of the operation processor includes a central processing unit. The memory may be removable memory detachably connected to the apparatus.

Thus, according to an embodiment, the apparatus comprises (processing) means for carrying out any of the embodiments of FIGS. 1 to 6. In an embodiment, the at least one processor 602, the memory 604 and/or a computer program code form an embodiment of (processing) means for carrying out the embodiments of the invention. In another embodiment, the at least one processor 702, the memory 704 and/or a computer program code form an embodiment of (processing means) for carrying out the embodiments of the invention.

In an embodiment at least some of the functionalities of the apparatus in FIGS. 6 and 7 may be shared between two physically separate devices forming one operational entity. Therefore, the apparatus may be seen to depict the operational entity comprising one or more physically separate devices for executing at least some of the described processes. The apparatus utilizing such shared architecture, may comprise a remote control unit

(RCU), such as a host computer or a server computer, operatively coupled (e.g. via a wireless or wired network) to a remote radio head (RRH) located in the base station. In an embodiment, at least some of the described processes may be performed by the RCU. In an embodiment, the execution of at least some of the described processes may be shared among the RRH and the RCU.

In an embodiment, the RCU may generate a virtual network through which the RCU communicates with the RRH. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

Embodiments described herein may be implemented in an arrangement, for example a communications network, where various techniques and methods described herein may be performed in a single entity or a plurality of entities. The entities may be logical or physical entities, for example eNBs UEs, UE modules, eNB modules or corresponding devices.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment.

It will be obvious to a person skilled in the art that, as technology advances, the inventive concept can be implemented in various ways. Further, it is clear to a person skilled in the art that the described embodiments may, but are not required to, be combined with other embodiments in various ways.

1-28. (canceled)

29. A method comprising:
initiating a device discovery process communications between user terminals capable of communicating on device-to-device and cellular communications links in the cellular communications network;
determining a first parameter indicating interference of a transmission from a first user terminal on a device-to-device communications link to a second user terminal;
determining a second parameter indicating interference of a transmission from the first user terminal on a cellular communications link, and
applying, on the basis of the first parameter exceeding the second parameter, asymmetric communications between the user terminals such that a transmission from the first user terminal to the second user terminal is communicated over the cellular communications links via infrastructure of the cellular communications network and a transmission from the second user terminal to the first user terminal is communicated over the device-to-device communications link.

30. The method according to claim 29, further comprising:
transmitting to at least one of the first user terminal and the second user terminal, information indicating allocated resources on at least one of a cellular communications link and a device-to-device communications link.

31. The method according to claim 29, further comprising:
allocating resources of the cellular network for communications between user terminals capable of communicating on device-to-device and cellular communications links;
transmitting a scheduling grant to at least one of the first user terminal and the second user terminal, for applying the allocated resources for the asymmetric communications between the user terminals in communications of at least one of user data and control information.

32. The method according to claim 29, further comprising:
obtaining a request for relaying a transmission transmitted over the device-to-device communications link unsuccessfully or for relaying a transmission targeted to the device-to-device link, and
carrying out the relaying of the transmission.

33. The method according to claim 29, further comprising:
analyzing, over the cellular communications link and over the device-to-device communications link, at least one of the following: transmission power and interference requirements, and
relaying a transmission targeted to the device-to-device communications link when communications over the cellular communications link is determined to be needed for fulfilling interference requirements.

34. The method according to claim 29, wherein resources of the cellular network are allocated for transmissions on at least one of a cellular communications link, a device-to-device communications link and both a cellular communications link and a device-to-device communications link, on the basis of a request.

35. The method according to claim 29, wherein at least one of the first parameter indicating interference and the second parameter indicating interference comprises at least one of the following: transmission power, pathloss and signal quality.

36. An apparatus comprising:
at least one processor and at least one memory including a computer program code, wherein the at least one memory and the computer program code are configured to, with the at least one processor, cause the apparatus at least to:
initiate a device discovery process for device-to-device communications between user terminals capable of communicating on device-to-device and cellular communications links in the cellular communications network;
determine a first parameter indicating interference of a transmission from a first user terminal on a device-to-device communications link to a second user terminal;
determine a second parameter indicating interference of a transmission from the first user terminal on a cellular communications link, and
apply, on the basis of the first parameter exceeding the second parameter, asymmetric communications between the user terminals such that a transmission from the first user terminal to the second user terminal is communicated over the cellular communications links via infrastructure of the cellular communications network and a transmission from the second user terminal to the first user terminal is communicated over the device-to-device communications link.

37. The apparatus according to claim 36, further comprising the at least one processor and the at least one memory causing the apparatus to:
transmit to at least one of the first user terminal and the second user terminal, information indicating allocated resources on at least one of a cellular communications link and a device-to-device communications link.

38. The apparatus according to claim 36, further comprising the at least one processor and the at least one memory causing the apparatus to:
allocate resources of the cellular network for communications between user terminals capable of communicating on device-to-device and cellular communications links;
transmit a scheduling grant to at least one of the first user terminal and the second user terminal, for applying the allocated resources for the asymmetric communications between the user terminals in communications of at least one of user data and control information.

39. The apparatus according to claim 36, further comprising the at least one processor and the at least one memory causing the apparatus to:
obtain a request for relaying a transmission transmitted over the device-to-device communications link unsuccessfully or for relaying a transmission targeted to the device-to-device link, and
carry out the relaying of the transmission.

40. The apparatus according to claim 36, further comprising the at least one processor and the at least one memory causing the apparatus to:
analyze, over the cellular communications link and over the device-to-device communications link, at least one of the following: transmission power and interference requirements, and
relay a transmission targeted to the device-to-device communications link when communications over the cellular communications link is determined to be needed for fulfilling interference requirements.

41. The apparatus according to claim 36, wherein resources of the cellular network are allocated for transmissions on at least one of a cellular communications link, a device-to-device communications link and both a cellular communications link and a device-to-device communications link, on the basis of a request.

42. The apparatus according to claim 36, wherein at least one of the first parameter indicating interference and the second parameter indicating interference comprises at least one of the following: transmission power, pathloss and signal quality.

43. A computer program embodied on a non-transitory computer-readable storage medium, the computer program comprising program code for controlling a processor to execute a process, the process comprising:
initiating a device discovery process communications between user terminals capable of communicating on device-to-device and cellular communications links in the cellular communications network;
determining a first parameter indicating interference of transmissions from a first user terminal on a device-to-device communications link to a second user terminal;
determining a second parameter indicating interference of transmissions from the first user terminal on a cellular communications link, and
applying, on the basis of the first parameter exceeding the second parameter, asymmetric communications between the user terminals such that a transmission from the first user terminal to the second user terminal is communicated over the cellular communications links via infrastructure of the cellular communications network and a transmission from the second user terminal to the first user terminal is communicated over the device-to-device communications link.

44. The computer program according to claim 43, the process further comprising:
causing to transmit to at least one of the first user terminal and the second user terminal, information indicating allocated resources on at least one of a cellular communications link and a device-to-device communications link.

45. The computer program according to claim 43, the process further comprising:
allocating resources of the cellular network for communications between user terminals capable of communicating on device-to-device and cellular communications links;
causing to transmit a scheduling grant to at least one of the first user terminal and the second user terminal, for applying the allocated resources for the asymmetric communications between the user terminals in communications of at least one of user data and control information.

46. The computer program according to claim 43, the process further comprising:
obtaining a request for relaying a transmission transmitted over the device-to-device communications link unsuccessfully or for relaying a transmission targeted to the device-to-device link, and
carrying out the relaying of the transmission.

47. The computer program according to claim 43, the process further comprising:
analyzing, over the cellular communications link and over the device-to-device communications link, at least one of the following: transmission power and interference requirements, and
relaying a transmission targeted to the device-to-device communications link when communications over the cellular communications link is determined to be needed for fulfilling interference requirements.
